(19) United States
(12) Patent Application Publication
(10) Pub. No.: US 2012/0239278 A1
(43) Pub. Date: Sep. 20, 2012

(54) METHOD AND CONTROL UNIT FOR OPERATING A VALVE

(76) Inventors: Thomas Becker, Esslingen/Zell (DE); Egbert Fuchs, Stuttgart-Feuerbach (DE); Felix Landhaeusser, Notzingen (DE); Holger Rapp, Ditzingen (DE); Thomas Gann, Gaertringen (DE); Ralph Kober, Gerlingen (DE)

(21) Appl. No.: 13/496,848

(22) PCT Filed: Aug. 23, 2010
(86) PCT No.: PCT/EP2010/062203

§ 371 Date: May 30, 2012

(30) Foreign Application Priority Data
Sep. 18, 2009 (DE) 102009029590.9

(51) Int. Cl. F02D 41/30

(52) U.S. Cl. 701/105

(57) ABSTRACT

A method for operating a valve actuated with the aid of an actuator, in particular, an injection valve of an internal combustion engine of a motor vehicle, where the actuator is activated using an activation signal characterizing a desired opening duration of the valve. The activation signal characterizing the desired opening duration is corrected as a function of a valve delay time, in order to obtain a corrected activation signal for activating the actuator; the valve delay time representing a temporal deviation between the activation signal and an actual change of an operating state of at least one component of the valve, in particular, of the valve element of an electromagnetic actuator, or of a valve needle.

### FIELD OF THE INVENTION

The present invention relates to a method for operating a valve actuated by an actuator, in particular, an injection valve of an internal combustion engine of a motor vehicle, where the actuator is activated using an activation signal characterizing a desired opening duration of the valve. In addition, the present invention relates to a control unit for implementing such a method.

### BACKGROUND INFORMATION

Valves of the type mentioned above that are actuated by actuators are used, for example, as fuel injectors of internal combustion engines having common-rail injection systems, as are used in motor vehicles. In a preferred specific embodiment, such fuel injectors have a control valve that is controlled by the actuator. In this context, opening the control valve causes, for example, a valve needle of the fuel injector to open, the needle lift of the valve needle preferably following a time characteristic of the lift that is primarily a function of a fuel pressure. Accordingly, closing the control valve via corresponding activation of the actuator reverses the movement direction of the valve needle of the injection valve and consequently initiates the closing operation. In the closing operation, the movement of the valve also follows a predetermined lift characteristic, which is mainly determined by the fuel pressure. Accordingly, an injection duration during the actuation of the fuel injector is mainly determined by the opening duration of the control valve. In the case of modern, pressure-equalized control valves, in particular, the valve seat is already substantially de-throttled at very small lifts, which means that the time interval between the lifting of a valve element of the control valve off its seat and the re-entry of the valve element into its seat may be defined as an effective opening duration of the control valve.

However, in conventional systems, the actual opening duration of the control valve contained in the fuel injector is not known, but only an activation duration during which the actuator of the fuel injector is activated for actuating the control valve. As a rule, so-called valve delay times, which are normally not constant, and which reduce a precision in the fuel metering in conventional systems, occur between a start of the activation of the actuator and the actual opening of the fuel injector, and between an end of the activation of the actuator and an actual closing time of the fuel injector.

### SUMMARY

An object of the present invention is to improve a method and a control unit of the type mentioned above, such that an increased precision is obtained with regard to the injection.

In accordance with the present invention, this object may be achieved by correcting the activation signal characterizing the desired opening duration, as a function of a valve delay time, in order to obtain a corrected activation signal for activating the actuator; the valve delay time representing a temporal deviation between the activation signal and an actual change of an operating state of at least one component of the valve, in particular, a valve needle.

The consideration of the valve delay time according to an example embodiment of the present invention may advantageously allow the activation signal used for activating the actuator to be corrected in such a manner, in particular, for subsequent activation instances, that an actual opening duration of the valve corresponds better to the desired opening duration.

A particularly advantageous specific embodiment of the method of the present invention provides that the activation signal be corrected as a function of an actual closing delay time of the valve ascertained, in particular, metrologically and/or based on a model; the actual closing delay time corresponding to a time lag between an end of the activation duration determined by the activation signal, and, an actual closing time. In this manner, fluctuating closing delay times, which may result, for example, due to the effects of ageing of valve components and variable environmental conditions (rail pressure, temperature, return back pressure), may also be taken into account.

If the injection valve operated according to the example embodiment of the present invention has a control valve, then the closing time of the control valve may also be advantageously considered in the calculation of the closing delay time.

A further increase in the precision of the example method according to the present invention may be advantageously achieved by taking into account a bounce of a valve needle of the valve during the determination of the actual closing delay time. With knowledge of the variables characterizing the bouncing event (e.g., opening duration during bouncing, number of bouncing events per activation cycle), the regular closing delay time may be increased by an appropriate factor, for example.

In a manner analogous to the present invention's consideration of the actual closing delay time, in a further advantageous specific embodiment of the operating method of the present invention, the activation signal may also be corrected as a function of an actual opening delay time of the valve, which corresponds to a time lag between a start of the activation duration determined by the activation signal and an actual opening time. The actual opening delay time may also be ascertained either metrologically and/or based on a model, which means that fluctuating opening delay times may also be advantageously taken into account.

If the injection valve operated according to the present invention has a control valve, then, in the scope of the method of the present invention, the opening time of the control valve may also be advantageously considered in the calculation of the opening delay time.

In a further, highly advantageous specific embodiment of the operating method of the present invention, an uncorrected activation duration is ascertained as a function of operating variables of the internal combustion engine, in particular, as a function of a setpoint quantity to be injected by the valve and/or of a fuel pressure, preferably using a first characteristics map; and that the uncorrected activation duration be corrected with the aid of a closing delay time correction value, which is ascertained as a function of the actual closing delay time.

A corresponding correction of an initially uncorrected activation duration with the aid of a correction value for the opening delay time is also possible.

A control unit may be used to implement the example embodiment of the present invention. The present invention may be implemented in the form of a computer program, which is able to be run on a processing unit of a control unit.

Additional features, possible uses and advantages of the present invention are derived from the following description of exemplary embodiments of the present invention, which are illustrated in the figures. In this context, all of the described or illustrated features form the subject matter of the present invention, either alone or in any combination, irrespective of their combination in the description and the figures.

### BRIEF DESCRIPTION OF THE DRAWINGS

FIGS. 1a, 1b, 1c show different operating states of an injection valve operated according to an example embodiment of the present invention.

FIG. 2 shows a time characteristic of operating variables of the injection valve from FIGS. 1a through 1c.

FIG. 3 shows a simplified flow chart of a conventional operating method.

FIGS. 4a, 4b, 4c show in each instance, a different specific embodiment of an operating method according to the present invention.

FIGS. 5a, 5b show further specific embodiments of the operating method according to the present invention.

FIG. 6 shows a state diagram of a further specific embodiment of the operating method according to the present invention.

### DETAILED DESCRIPTION OF EXAMPLE EMBODIMENTS

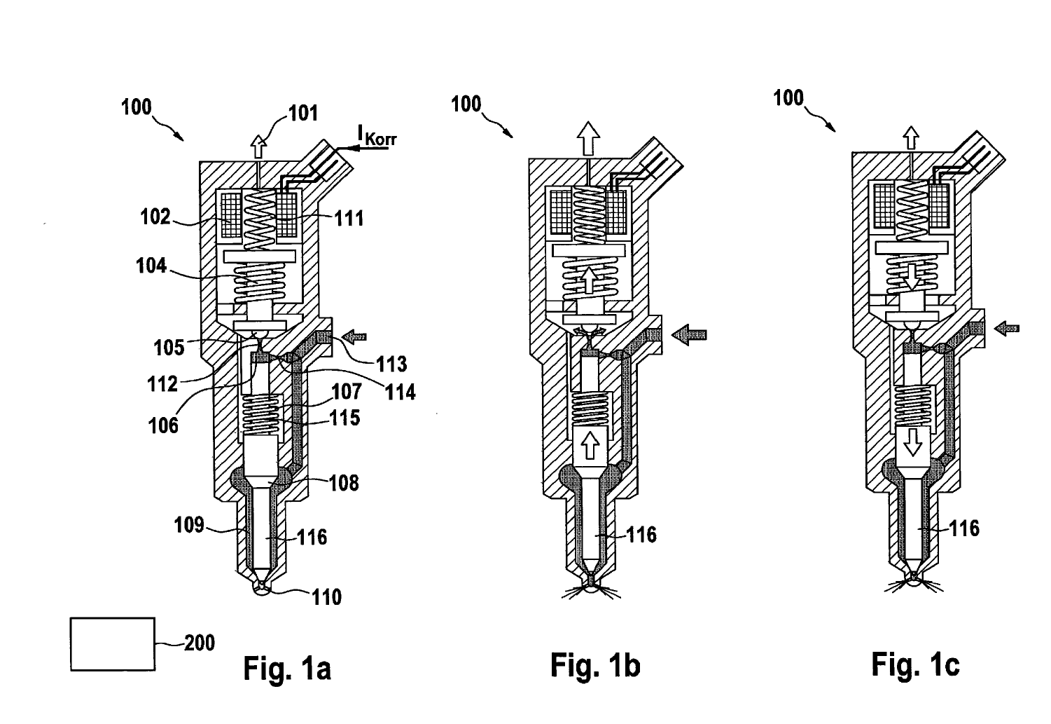

FIGS. 1a through 1c show a specific embodiment of an injection valve 100 of a common-rail fuel injection system of an internal combustion engine in different operating states of an injection cycle, the injection valve being designed to inject fuel.

FIG. 1a shows injection valve 100 in its resting state, in which it is not energized by the control unit 200 assigned to it. In this connection, a solenoid valve spring 111 presses a valve ball 105 into a seat of outflow throttle 112 provided for it, which means that a fuel pressure corresponding to the rail pressure may build up in valve control chamber 106, as also prevails in the region of high-pressure connection 113.

The rail pressure is also present in chamber volume 109, which surrounds valve needle 116 of injection valve 100. The forces applied to the end face of control piston 115 by the rail pressure, as well as the force of nozzle spring 107, hold valve needle 116 closed in opposition to an opening force that acts upon pressure shoulder 108 of valve needle 116.

Starting out from the resting state depicted in FIG. 1a, FIG. 1b shows injection valve 100 in its open state, which it assumes in the following manner when activated by control unit 200: using control unit 200, the electromagnetic actuator presently formed by the solenoid coil 102 designated in FIG. 1a and the magnet armature 104 interacting with solenoid coil 102 is acted upon by an activation current I_{corr}, which constitutes an activation signal and is corrected according to the present invention, in order to cause the solenoid valve 104, 105, 112 functioning as a control valve to open rapidly. In this connection, the magnetic force of electromagnetic actuator 102, 104 exceeds the spring force of valve spring 111 (FIG. 1a), so that magnet armature 104 lifts valve ball 105 off its valve seat and, with this, opens outflow throttle 112.

With the opening of outflow throttle 112, fuel may now flow off out of valve control chamber 106 into the cavity situated above it, as shown in FIG. 1b, cf. the arrows, and through a fuel return line 101 back to a fuel tank not shown. Inflow throttle 114 prevents a complete pressure equalization between the rail pressure present in the region of high-pressure connection 113 and the pressure in valve control chamber 106, which means that the pressure in valve control chamber 106 decreases. This results in the pressure in valve control chamber 106 becoming less than the pressure in chamber volume 109, which still corresponds to the rail pressure. The decreased pressure in valve control chamber 106 produces a correspondingly decreased force on control piston 115 and therefore results in the opening of injection valve 100, that is, the lifting-off of valve needle 116 from its valve needle seat in the region of spray orifices 110. This operating state is illustrated in FIG. 1b.

Subsequently, i.e., after lifting off from the valve needle seat, valve needle 116 follows a generally ballistic trajectory by the action of, primarily, the hydraulic forces in chamber volume 109 and in valve control chamber 106.

As soon as electromagnetic actuator 102, 104 (FIG. 1a) is no longer activated by control unit 200, valve spring 111 presses magnet armature 104 down, as illustrated in FIG. 1c, so that valve ball 105 consequently occludes outflow throttle 112. Valve needle 116 is now moved down by the fuel continuing to flow through inflow throttle 114 into valve control chamber 106, the valve needle following a generally ballistic trajectory until it reaches its closing position again. This state is shown in FIG. 1c.

The fuel injection is brought to an end, as soon as valve needle 116 reaches its valve needle seat in the region of spray orifices 110 and closes them.

All in all, the injection duration of the fuel injection effected by injection valve 100 is generally determined by the opening duration of control valve 104, 105, 112.

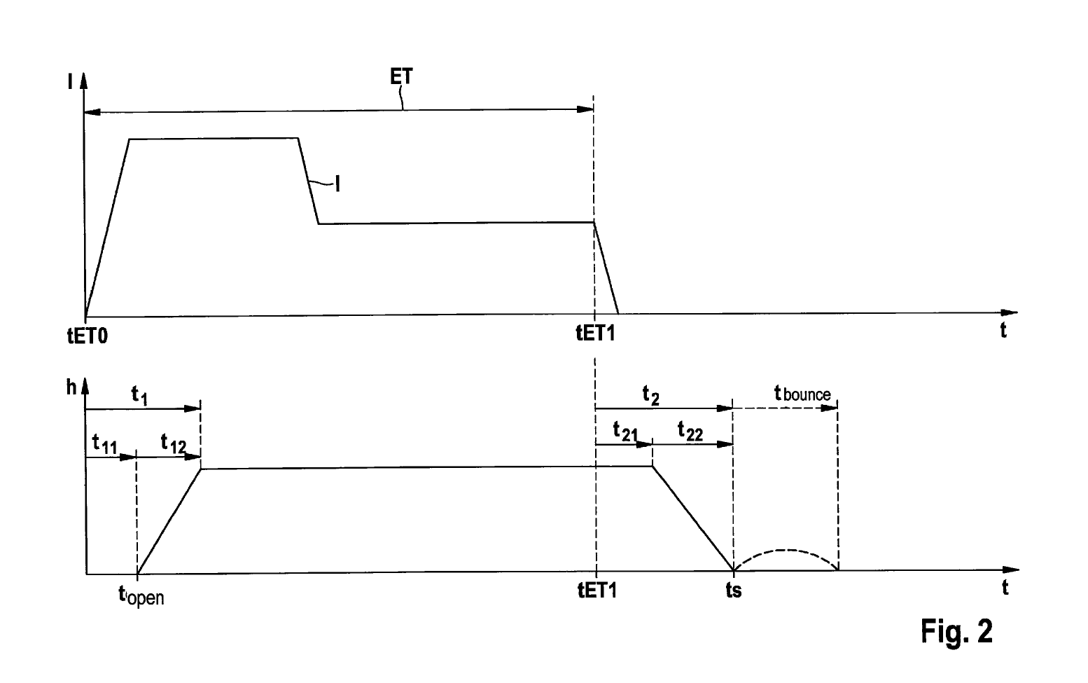

FIG. 2 schematically illustrates a time characteristic of the operating variables activation current I and valve lift h of valve ball 105 (FIG. 1a) of the control valve, as is produced during an activation cycle within the scope of an injection of fuel.

First of all, electromagnetic actuator 102, 104 (FIG. 1a) of injection valve 100 is energized at time t_{ET0}, in order to allow valve ball 105 to be lifted out of its resting position in the region of outflow throttle 112 and, consequently, to open the control valve. Thus, time t_{ET0} designates a start of activation duration ET of electromagnetic actuator 102, 104, and therefore, of control valve 104, 105, 112, as well, of injection valve 100, the activation duration of the electromagnetic actuator being determined by activation signal I.

Due to a non-zero opening delay time t₁₁, valve ball 105 first moves out of its closing position in the region of outflow throttle 112 as of actual opening time tₒₚₑₙ. Opening delay time t₁₁ is determined, inter alia, by the mechanical and hydraulic configuration of injection valve 100 and of the control valve.

As shown in the diagram of FIG. 2, the supply of power to electromagnetic actuator 102, 104 continues up to the end t_{ET1} of activation duration ET and may also have different current values over activation duration ET, as illustrated in FIG. 2. In the present case, a larger current level is selected for approximately the first half of activation duration ET than for the second half of activation duration ET, in order to allow the control valve to open particularly rapidly.

According to the graph that is illustrated in FIG. 2 and represents valve lift h of valve ball 105, the control valve has reached its completely open state after time t₁, which spans, apart from above-described opening delay time t₁₁, the time t₁₂ that is necessary for valve ball 105 to move out of its closed position into its open position.

As shown in FIG. 2, a closing delay time t₂ ensues subsequent to end t_{ET1} of activation duration ET. In the configuration of injection valve 100 according to FIGS. 1a, 1b and 1c, closing delay time t₂ is yielded from a holding delay time t₂₁ and a closing flight time t₂₂. The control valve of injection valve 100 does not assume its closed state again until actual closing time tₛ=t_{ET1}+t₂.

If valve ball 105 of the control valve also exhibits bouncing action during its closing operation, then, due to this, further, relatively brief time intervals, during which the control valve is not completely closed, and during which fuel from valve control chamber 106 is accordingly discharged through outflow throttle 112, also occur after actual closing time tₛ. The consideration of such bounce times t_{bounce} as an effective extension of closing delay time t₂ is described below in detail.

According to an example embodiment of the present invention, it is provided that activation signal I (in this case, an activation current), which characterizes a desired opening duration for injection valve 100, be corrected as a function of at least one valve delay time, in order to obtain a corrected activation signal I_{corr} (FIG. 1a) for activating electromagnetic actuator 102, 104.

That is, in one specific embodiment of the method according to the present invention, activation signal I, in particular, its parameter characterizing activation duration ET (FIG. 2), is corrected as a function of at least one valve delay time. This may allow the control valve to be controlled more precisely, in particular, with regard to its opening duration, which means that the injection duration of injection valve 100 may also be set more accurately, and consequently, the precision of the fuel metering may be improved.

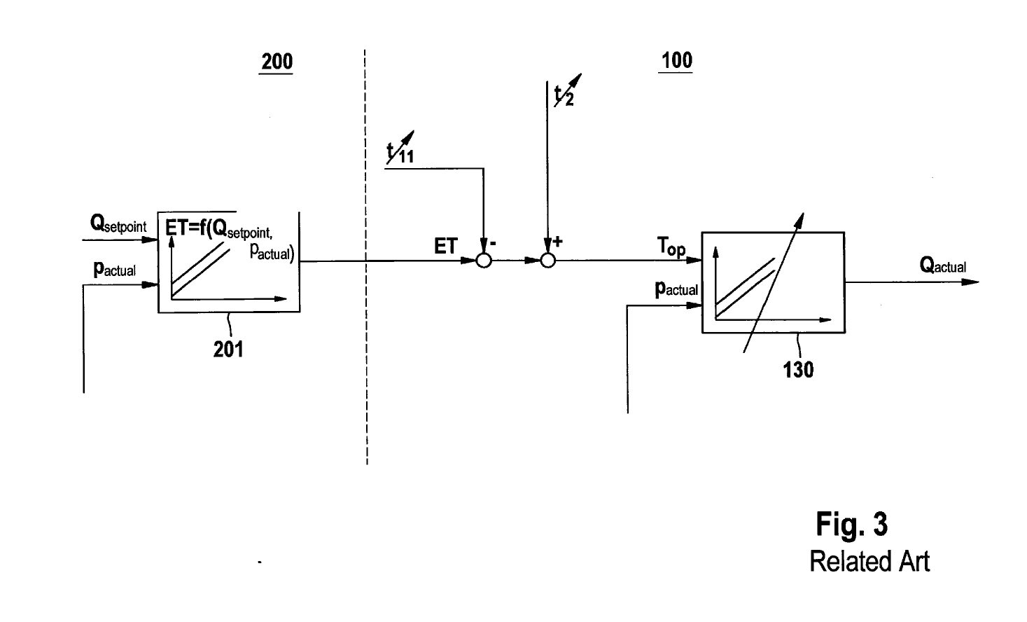

However, a conventional operating method for an injection valve 100, which does not carry out a correction of activation signal I or its parameter ET in accordance with the present invention, is initially described below with reference to the flow chart shown in FIG. 3.

In a first functional block 201 implemented, for example, using a characteristics map, in the conventional operating method, activation duration ET for the activation of electromagnetic actuator 102, 104 of the control valve is ascertained with a corresponding current I (FIG. 2) as a function of the operating variables fuel quantity to be injected Qₛₑₜₚₒᵢₙₜ and fuel pressure p_{actual}.

As it were, when controlling the control valve with the aid of this signal that represents activation duration ET and is ascertained in a conventional manner, delay times t₁₁, t₂, which are described above in further detail and are, generally, variable over time, join conventionally ascertained activation duration ET as disturbance variables, which means that control chamber 106 of injection valve 100 is controlled using a modified activation variable Tₒₚ=ET−t₁₁+t₂. In FIG. 3, tolerances that may occur in the high-pressure hydraulics of injection valve 100 are symbolized by functional block 130. In the conventional system, based on the above-described activation with the aid of activation signal Tₒₚ, and in the case of the given fuel pressure p_{actual}, the fuel quantity actually injected Q_{actual} is generated at the output of functional block 130.

Due to the influence of the generally unwanted delay times t₁₁, t₂ already described above, the fuel quantity actually injected Q_{actual} does not, generally, correspond to the setpoint fuel quantity to be injected Qₛₑₜₚₒᵢₙₜ, which is the basis of the calculation of activation duration ET in control unit 200 (FIG. 1a).

Accordingly, the example method of the present invention advantageously provides a correction of activation duration ET as a function of at least one valve delay time of injection valve 100 or of its control valve.

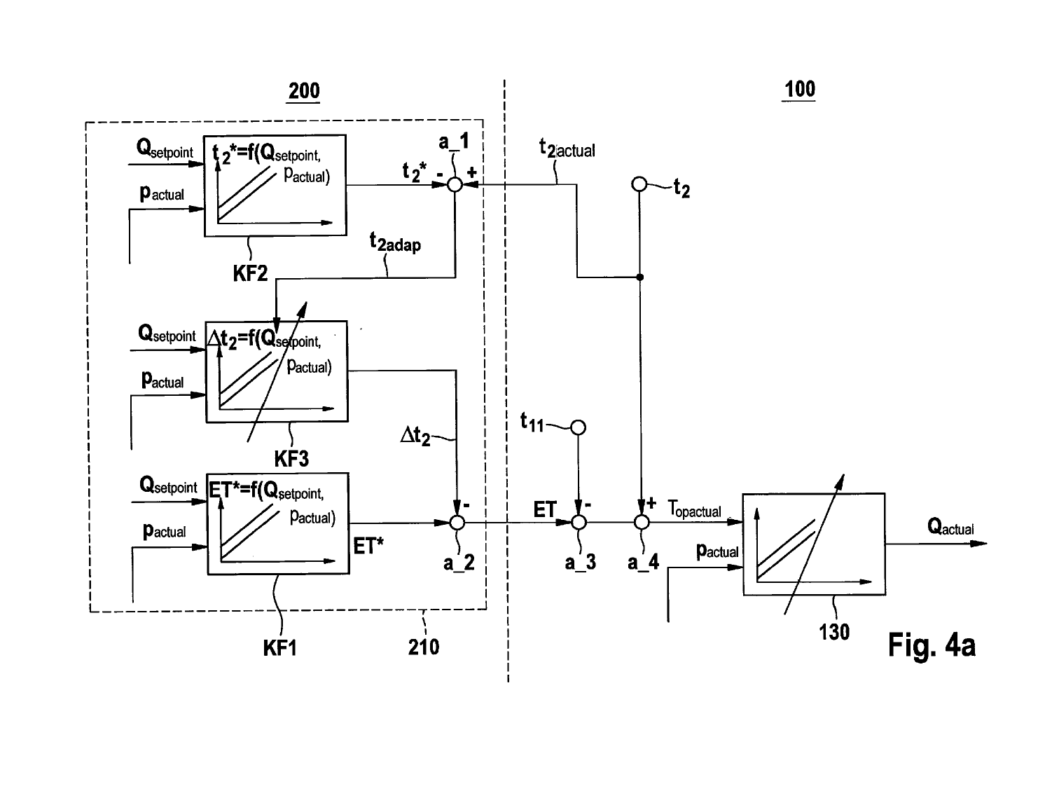

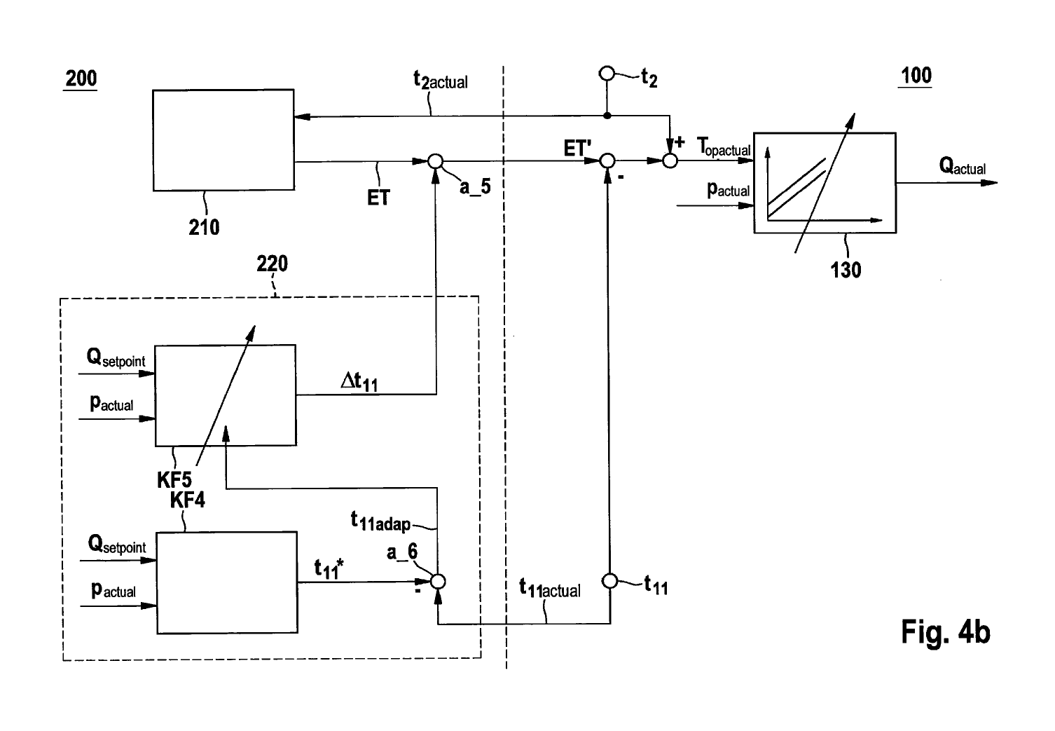

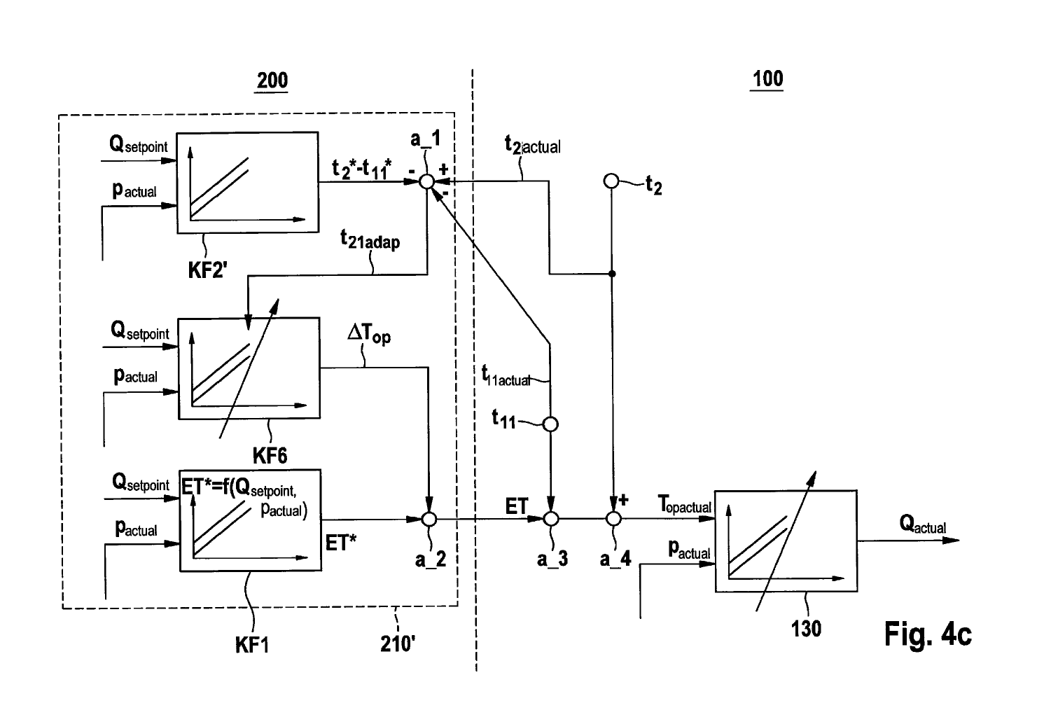

A first specific embodiment of the operating method according to the present invention is described below with reference to the flow chart shown in FIG. 4a. In this connection, a correction of an initially uncorrected activation duration ET* is provided on the basis of a metrologically acquired, closing delay time t_{2actual}.

Uncorrected activation duration ET* is presently calculated by a first characteristics map KF1 as a function of operating variables Qₛₑₜₚₒᵢₙₜ, p_{actual}. First characteristics map KF1 is preferably a static characteristics map, which remains unchanged over the entire service life of control unit 200 and of injection valve 100.

A setpoint closing delay time t₂*, which is subtracted from the actual closing delay time t_{2actual} metrologically determined according to the present invention in first adder a_1, is ascertained by second characteristics map KF2, from setpoint quantity Qₛₑₜₚₒᵢₙₜ and rail pressure p_{actual}; the second characteristics map also being implemented in control unit 200. Accordingly, a closing delay time adaptation value t_{2adap}=t_{2actual}−t₂* is generated on the output side of first adder a_1.

Setpoint closing delay time t₂* supplied by characteristics map KF2 represents the closing delay time t₂, which the control valve must have in order that, given above-described interference effects t₁₁, t₂, uncorrected activation duration ET* produces the desired valve opening duration of the control valve and, consequently, the desired injection quantity.

The closing delay time adaptation value t_{2adap} ascertained according to the present invention is supplied to a third characteristics map KF3.

From input variables Qₛₑₜₚₒᵢₙₜ and p_{actual} third characteristics map KF3 ascertains a closing delay time correction value Δt₂, which is used in accordance with the present invention to correct uncorrected activation duration value ET*; this is arithmetically performed by subtracting closing delay time correction value Δt₂ from uncorrected activation duration ET* with the aid of second adder a_2: ET=ET*−Δt₂.

Closing delay time adaptation value t_{2adap} acts advantageously upon adaptively configured, third characteristics map KF3 and influences, in this manner, in accordance with the present invention, the calculation of closing delay time correction value Δt₂ as a function of actual closing delay time t_{2actual}. By suitably calibrating third characteristics map KF3 and suitably modifying adaptive characteristics map KF3 using closing delay time adaptation value t_{2adap}, in this manner, it is advantageously ensured that in response to a changing, actual closing delay time t_{2actual}, closing delay time correction value Δt₂ is also correspondingly changed.

According to a specific embodiment, the measurement of actual closing delay time t_{2actual} in accordance with the present invention may be carried out continuously or also periodically. As an alternative, it is possible to only determine actual closing delay time t_{2actual} metrologically, e.g., ascertain it based on a model, if specifiable, e.g., applicable, acceptance conditions are present. In addition, the manner in which closing delay time adaptation value t_{2adap} influences adaptive, third characteristics map KF3 may be realized in various ways in a manner known to one skilled in the art, e.g., including filtering, consideration of the effect on adjacent points of reference of third characteristics map KF3, etc. A measuring principle for the closing delay time is described, for example, in German Patent No. DE 38 43 138.

Therefore, according to the present invention, the method illustrated in FIG. 4a provides that a corrected value for the activation duration ET, which is used for activating injection valve 100, i.e., its electromagnetic actuator 102, 104, be obtained from an uncorrected value for activation duration ET*, at the output of second adder a_2. Using the correct signs, the delay times t₁₁, t₂ occurring based on principle are added by further adders a_3, a_4 to the driving value ET corrected according to the present invention, so that the input side of the functional block 130 representing a characteristic curve of the hydraulic high-pressure components is supplied the variable T_{opactual}=ET−t₁₁+t₂ for the activation duration, as well as actual fuel pressure p_{actual}; as a result, the fuel quantity actually injected Q_{actual} is generated at the output of functional block 130 in a conventional manner.

Due to the correction of activation duration ET as a function of the closing delay time t₂ that is presently determined metrologically in accordance with the present invention, it produces an agreement between fuel quantity actually injected Q_{actual} and desired fuel quantity Qₛₑₜₚₒᵢₙₜ that is better than the conventional method schematically represented in FIG. 3. The interfering influence of the valve delay times on the injection quantity may be markedly reduced, using the principle of the present invention.

The flow chart described below with reference to FIG. 4b represents a further specific embodiment of the operating method of the present invention, in which in addition to closing delay time t₂, opening delay time t₁₁ of the control valve is also taken into account in order to correct activation duration ET.

In FIG. 4b, the functional blocks described above with reference to FIG. 4a and implemented in control unit 200 are combined in functional block 210, whose input side, as already described, is supplied the actual closing delay time t_{2actual} considered in accordance with the present invention, and which, as shown in the detailed representation from FIG. 4a, outputs, at its output, a value ET for the activation duration that is corrected by closing delay time correction value Δt₂.

To take opening delay time t₁₁ into account, an example embodiment of the present invention provides further functional block 220 in FIG. 4b.

In a manner analogous to the function of second characteristics map KF2 shown in FIG. 4a, second functional block 220 in FIG. 4b has a fourth characteristics map KF4, which calculates a setpoint opening delay time t₁₁* from the operating variables Qₛₑₜₚₒᵢₙₜ, p_{actual}.

Just as in the case of variable t₂*, setpoint opening delay time t₁₁* is a delay time, as is yielded as a function of operating variables, for a reference injection valve, for example, an injection valve 100 whose condition is new. Therefore, to initialize characteristics maps KF2, KF4, variables t₂*, t₁₁* may be ascertained, for example, by measurements at the reference valves at all operating points (Qₛₑₜₚₒᵢₙₜ, p_{actual}) Of interest.

According to the present invention, an opening delay time adaptation value t_{11adap} is calculated by subtraction of setpoint opening delay time t₁₁* from metrologically determined, actual opening delay time t₁₁, which is rendered arithmetically possible by adder a_6.

Opening delay time adaptation value t_{11adap} is supplied to fifth characteristics map KF5, which is an adaptive characteristics map, and which allows a modification of the functional relationship between an opening delay time correction value Δt₁₁ and operating variables Qₛₑₜₚₒᵢₙₜ, p_{actual} supplied on the input side and opening delay time adaptation value t_{11adap} in a manner analogous to third characteristics map KF3 shown in FIG. 4a.

In this manner, an opening delay time correction value Δt₁₁, which is dynamically obtained as a function of actual delay time t_{11actual} and setpoint opening delay time t₁₁*, may be calculated over the entire operation of injection valve 100.

Using adder a_5, opening delay time correction value Δt₁₁ is combined with value ET for the activation duration, as is obtained by the functional block 210 already described with reference to FIG. 4a.

The value ET′ for the activation duration that is corrected by the two valve delay times t₁₁ and t₂ in accordance with the present invention is supplied to injection valve 100, where it is initially subjected to the influence of real valve delay times t₁₁, t₂, as already described with reference to FIG. 4a, so that variables T_{opactual}=ET′−t₁₁+t₂, and p_{actual} again obtained for application to the input side of functional block 130.

In the exemplary embodiment of the operating method of the present invention illustrated in FIG. 4b, particularly good agreement of the fuel quantity actually injected Q_{actual} with setpoint quantity Qₛₑₜₚₒᵢₙₜ is provided due to the consideration of the two valve delay times t₁₁, t₂ according to the present invention.

A simplified functional structure for correcting the activation signal or activation duration ET as a function of the two valve delay times t₁₁, t₂ is shown in FIG. 4c.

In the specific embodiment shown in FIG. 4c, a modified, second characteristics map KF2′, which outputs the difference t₂* −t₁₁* as a function of input variables Qₛₑₜₚₒᵢₙₜ, p_{actual} is provided in place of second characteristics map KF2 shown in FIG. 4a. According to the present invention, this difference is subtracted from the difference of actual valve delay times t_{11actual}, t_{2actual} by adder a_l to obtain a further adaptation signal t_{21adap} at the output of first adder a_1. This further adaptation signal t_{21adap} acts upon characteristics map KF6, which, in place of the correction values Δt₁₁, Δt₂ considered up to then, now outputs a correction value ΔTₒₚ for the opening time as a function of operating variables Qₛₑₜₚₒᵢₙₜ, p_{actual} and further adaptation value t_{21adap}.

Correction value ΔTₒₚ for the opening time is added to uncorrected activation duration value ET* by second adder a_2, so that at the output of second adder a_2, an activation value ET corrected according to the present invention is generated for output to injection valve 100.

That is, in the specific embodiment shown in FIG. 4c, the present invention's consideration of valve delay times t₁₁, t₂ is implemented by characteristics maps KF2′, KF6, and not distributed over characteristics maps KF2, KF3 (FIG. 4a) and KF4, KF5 (FIG. 4b). Functionality 210′ is realized, in turn, in control unit 200 (FIG. 1a) or a processing unit contained in it, such as a microcontroller or digital signal processor (DSP).

In characteristics maps KF2, KF2′, KF3, KF4, KF5, KF6, uncorrected activation duration ET* may also be used as an input variable in place of setpoint fuel quantity Q_{setpoint.}

According to a further specific embodiment of the operating method of the present invention, the situation of the bouncing of valve ball 105 (FIG. 1a) during the closing of the control valve, which was already described with reference to FIG. 2, may be taken into account by considering, in place of closing delay time t₂ (FIG. 2), a closing delay time t₂+t_{2p,eff} increased by a virtual closing duration extension t_{2p,eff}. In this connection, virtual closing duration extension t_{2p,eff} indicates the time that is to be added to closing delay time t₂, in order to appropriately take into account the increased quantity obtained during the fuel injection due to the bouncing.

The virtual closing duration extension may be ascertained, for example, as a function of a characteristics map stored in control unit 200 or a characteristic curve. The extended closing delay time may then be used in place of previous value t₂ or t_{2actual} for correcting the value for activation duration ET in accordance with the present invention.

According to a particularly preferred variant of the present invention, at the beginning of an operating period of injection valve 100, setpoint value characteristics maps KF2, KF2′, KF4 may be adaptively changeable for a limited operating-duration performance interval. In this variant, the corresponding actual values of an injection valve 100 whose condition is new are initially written to the setpoint value characteristics map. A result of this is that only changes in the valve delay time of injection valve 100 in the course of its service life are corrected, but not deviations of its valve delay time in the new state from a specified setpoint value.

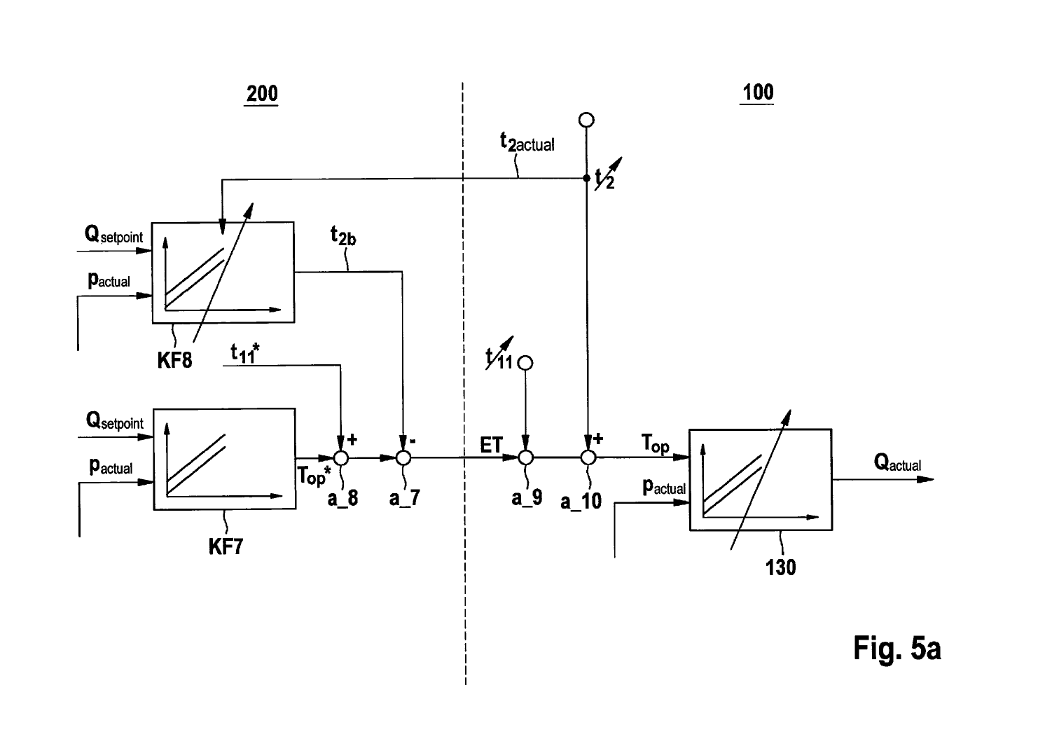

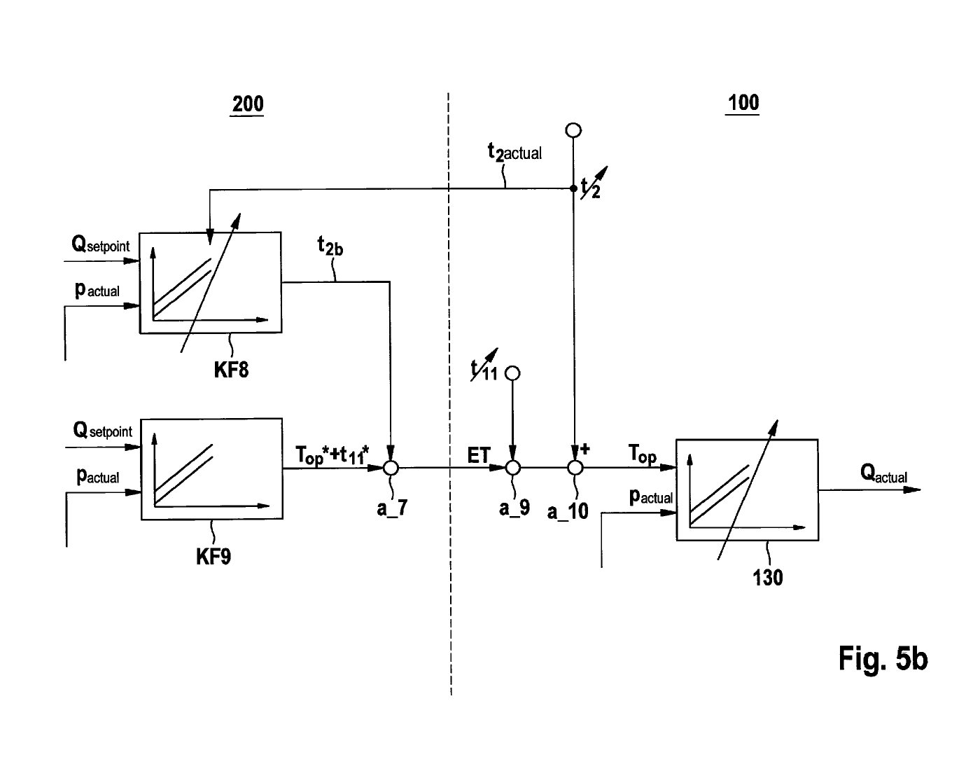

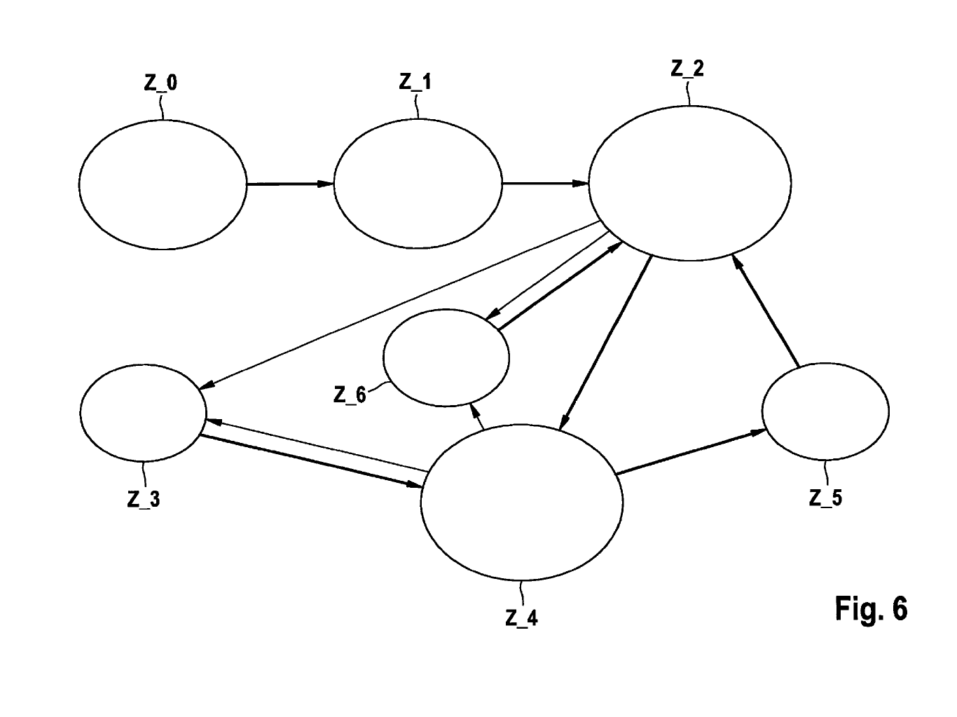

FIG. 5a shows a flowchart for implementing a further specific embodiment of the operating method according to the present invention.

First of all, in place of activation duration ET, for the driving of injection valve 100, i.e., of its electromagnetic actuator 102, 104 with activation current I, a setpoint opening duration Tₒₚ* of the control valve of injection valve 100 is ascertained by characteristics map KF7 from operating variables Qₛₑₜₚₒᵢₙₜ, p_{actual}. Characteristics map KF7 preferably remains unchanged over the entire service life of injection valve 100, that is, it is a static characteristics map.

According to the present invention, expected opening delay time t₁₁* is added to setpoint opening duration Tₒₚ* by adder a_8. Depending on the opening characteristics of the control valve, expected opening delay time t₁₁* may be a fixed value or also a value ascertained by a preferably static characteristics map, e.g., as a function of setpoint quantity Qsetpoint and fuel pressure p_{actual}.

The specific embodiment of the operating method according to the present invention, which is illustrated in FIG. 5a, further provides for the calculation of a correction value t_{2b}, which is obtained by an adaptive characteristics map KF8 as a function of operating variables Qₛₑₜₚₒᵢₙₜ, p_{actual}. Characteristics map KF8 is configured to be adaptive and accordingly allows correction value t_{2b} to be generated variably as a function of actual closing delay time t_{2actual}, which is presently determined metrologically, as already described several times.

Using adder a_7, correction value t_{2b} is taken into account in the calculation of activation duration ET as follows: ET=Tₒₚ*+t₁₁*−t_{2b}. Therefore, the effect of actual closing delay time t₂ on the injection quantity may be compensated for by appropriately adjusting activation duration ET. The further “processing” of activation duration ET inside of injection valve 100 in FIG. 5a takes place in a manner analogous to the above-described specific embodiments of the present invention; the actual valve delay times t₁₁, t₂ that constitute the disturbance variables being taken into account via adders a_9 and a_10.

A further structure of a flow chart representing an example embodiment of the method of the present invention, which is simplified in comparison with the variant of the present invention described above with reference to FIG. 5a, is specified in FIG. 5b.

Here, in place of setpoint opening duration Tₒₚ* via characteristics map KF7, the sum of setpoint opening duration Tₒₚ* and expected opening delay time tₙ* is already obtained by means of characteristics map KF9 as a function of operating variables Qₛₑₜₚₒᵢₙₜ, p_{actual}. Correction value t_{2b} is obtained in a manner analogous to the method variant described with regard to FIG. 5a, and the sum Tₒₚ*+t₁₁* is added via adder a_7. Thus, at the output of adder a_7, a corrected value for activation duration ET is again obtained, which is supplied to injection valve 100 in accordance with the present invention.

For the case in which a measured value or value ascertained on the basis of a model is also available for opening delay time t₁₁, then, in the variants of the present invention described with reference to FIGS. 5a and 5b, the actual opening delay time really measured t₁₁ or the opening delay time ascertained on the basis of a model may be used in place of expected opening delay time t₁₁*. To this end, a separate computational step may be provided in which actual opening delay time t _{1actual} is processed comparably to functional block 220 shown in FIG. 4b and used for modifying an adaptive characteristics map for a corresponding correction value Δt₁₁.

FIG. 6 shows a state diagram of a further preferred, specific embodiment of the operating method according to the present invention, which describes a learning operation in the scope of which a characteristics map used for performing the present invention's correction of activation signal I or ET is supplied with characteristics map values that correspond to an injection valve 100 used. For example, characteristics map KF2 from FIG. 4a may be filled with data in the manner described below with reference to FIG. 6.

State Z_0 corresponds to a condition of control unit 200 (FIG. 1a) upon delivery, in which characteristics map KF2 is initialized with zero values, for example.

In subsequent state Z_1, characteristics map KF2 is initially supplied with average closing duration values or closing delay times t₂* of an injection valve regarded as ideal, which are obtained, for example, in the scope of a series of measurements over several injection valves and held in reserve for this purpose at the end of a manufacturing process of injection valve 100. Simultaneously to this, the further characteristics map KF3 (FIG. 4a) associated with characteristics map KF2 and also referred to as a correction characteristics map is initialized with zero values.

State Z_2, which is also referred to as new-state learning phase, and in which actually-occurring, closing delay times t₂* of injection valve 100 are determined, e.g., metrologically, and stored in characteristics map KF2 as a function of operating point, follows state Z_1. In comparison with preceding states Z_0, Z_1, state Z_2 is characterized in that it may first be assumed, when injection valve 100 initiates its operation in the injection system of the internal combustion engine. A separate characteristics map KF2, KF3 is advantageously provided for each injection valve 100 of the internal combustion engine, in order to take into account, inter alia, deviations in parts.

New-state learning phase Z_2 may also advantageously provide low-pass filtering of closing delay times t₂* to be learned, in order to minimize the negative influence of outliers on the learning process.

Since characteristics map KF2 is normally formed by a predefined grid of value pairs (Qₛₑₜₚₒᵢₙₜ, p_{actual}) which are each assigned a closing delay time value t₂*, the use of interpolation or smoothing methods may also be provided, in order to determine, starting out from the values of Qₛₑₜₚₒᵢₙₜ, p_{actual} actually occurring during the operation of injection valve 100, which pair of values (Qₛₑₜₚₒᵢₙₜ, p_{actual}) of characteristics map KF2 is assigned the value to be learned, or to what extent a value to be learned is to be modified, e.g., as a function of adjacent, already learned values of characteristics map KF2, in order to take into account a difference between the actual values for Qₛₑₜₚₒᵢₙₜ, p_{actual} and the grid of characteristics map KF2.

The values of correction characteristics map KF3 also remain initialized with zero values during state Z_2. After each operating cycle, the values of characteristics map KF2 learned during state Z_2 are continuously saved, so that they are used as a starting point for a subsequent driving cycle.

New-state learning phase Z_2 is preferably limited to a specifiable maximum number of learning cycles per operating point, i.e., per pair of values (Qₛₑₜₚₒᵢₙₜ, p_{actual}) and/or to a specifiable period of time. A failure to reach a minimum required learning change is used as a further criterion for the successful completion of the learning phase, i.e., as soon as the learning process results in only a slight modification of values already learned, the learning process is regarded as complete.

As soon as these criteria are satisfied, characteristics map KF2 is regarded as sufficiently adapted to respective injection valve 100 and, consequently, as “learned.” The completion of the learning operation is represented by a state transition from Z_2 to Z_4. State Z_4 is followed by a correction phase described later in further detail. However, the further states of the learning process of the present invention shown in FIG. 6 are initially described.

Starting out from new-state learning phase Z_2, the situation may occur in which control unit 200 (FIG. 1a) is replaced, e.g., due to a defect. In this case, the operation branches from state Z_2 into state Z_3, in which initially empty characteristics map KF2 of the replacement unit is filled with average closing delay time values t₂* of an injection valve regarded as ideal, cf. state Z_1, and subsequently, a new-state learning phase takes place again in order to ultimately be able to assume state Z_4.

Starting out from new-state learning phase Z_2, the replacement of a single injection valve results in a state transition into state Z_6, in which only the characteristics map KF2 assigned to replaced injection valve is initially filled with average closing delay time values t₂* of an injection valve regarded as ideal.

The replacement of all of the injection valves results in state Z_5, which has a functionality comparable to state Z_1.

As soon as state Z_4 is reached, and consequently, a learning process for characteristics map KF2, i.e., all of the characteristics maps of the individual injection valves 100, is complete, a correction phase may commence. During the correction phase, closing delay time values actually occurring t₂* are determined and subtracted from the characteristics map values of characteristics map KF2. The differential values obtained in doing this or derived from this, cf. variable t_{2adap} from FIG. 4a, are stored for the corresponding operating point in correction characteristics map KF3, which, since then, has been initialized with zero values. The differential values may be stored in correction characteristics map KF3 in the same way as described above for the storing of values in characteristics map KF2, that is, using interpolation and/or smoothing methods, etc.

After each operating cycle, correction characteristics map KF3 is continuously stored as a starting point for a subsequent operating cycle. The characteristics map KF2 already learned is not changed anymore during the correction phase.

In addition, a weighting characteristics map may also be provided, which takes into account a shift and an amplification of a change of activation duration ET on a closing duration change as a function of operating point. An output variable of the weighting characteristics map may be advantageously combined with the output variable of correction characteristics map KF3, in order to influence the activation signal or activation duration ET.

Instead of directly storing learned values of an injection valve 100 in characteristics map KF2 (FIG. 4a), it is also possible to store the learned values directly in a memory assigned to injection valve 100, or even in a memory integrated in it. In this manner, injection valve 100 may already be “learned” during its manufacture, in the sense of forming characteristics map KF2, and in the event of a later replacement of a, e.g., defective stock valve with injection valve 100, control unit 200 may take the characteristics map values of “new” injection valve 100 directly out of the memory, which means that the learning process for characteristics map KF2 after the valve replacement is advantageously omitted, and consequently, the new injection valve may be immediately operated in accordance with the example embodiment of the present invention, in order to achieve particularly precise fuel injection.

The example method of the present invention is also advantageously applicable to other actuator-operated valves in the form of fuel injectors of internal combustion engines, in which valve delay times of the described type occur. In general, the method of the present invention may be applied to all actuator-operated valves, which do not have a delay-free chain of action between activation of the actuator and valve operation. The individual causes of delays, such as tolerances of the hydraulic components, mechanical play, rise times of electrical activation signals, e.g., due to parasitic inductances, etc., are not of significance for the functioning of the principle according to present invention. In particular, the method of the present invention may also be applied to “directly” actuated valves, i.e., valves, in which actuator 102, 104 (FIG. 1a) acts directly upon, e.g., valve needle 116, and in which the chain of action between actuator 102, 104 and valve needle 116 does not include a control valve 104, 105, 112, if the corresponding delay times are ascertainable or metrologically determinable.

1-12. (canceled)

13. A method for operating an injection valve of an internal combustion engine of a motor vehicle activated with the aid of an actuator, where the actuator is activated using an activation signal characterizing a desired opening duration of the valve, the method comprising:
correcting the activation signal characterizing the desired opening duration as a function of a valve delay time to obtain a corrected activation signal for activating the actuator, the valve delay time representing a temporal deviation between the activation signal and an actual change of an operating state of at least one component of the valve;
ascertaining an uncorrected activation duration as a function of operating variables of the internal combustion engine;
correcting the uncorrected activation duration with the aid of a closing delay time correction value, which is ascertained as a function of an actual closing delay time;
ascertaining a setpoint closing delay time as a function of operating variables of the internal combustion engine;
ascertaining a closing delay time adaptation value as a function of a deviation between an actual closing delay time and the setpoint closing delay time;
ascertaining the closing delay time correction value as a function of operating variables of the internal combustion engine, and as a function of the closing delay time adaptation value; and
activating the actuator using the corrected activation signal.

14. The method as recited in claim 13, wherein the at least one component of the valve includes a valve needle.

15. The method as recited in claim 13, wherein the activation signal is corrected as a function of an actual closing delay time of the valve at least one of ascertained metrologically, and based on a model, the actual closing delay time of the valve corresponding to a time lag between an end of the activation duration determined by the activation signal, and an actual closing time.

16. The method as recited in claim 15, wherein a bounce of at least one of a valve needle and another valve element of the valve is considered during the determination of the actual closing delay time.

17. The method as recited in claim 13, wherein the activation signal is corrected as a function of an actual opening delay time of the valve ascertained at least one of metrologically and based on a model, the actual opening delay time of the valve corresponding to a time lag between a start of an activation duration determined by the activation signal, and an actual opening time.

18. The method as recited in claim 13, wherein the uncorrected activation duration is ascertained as a function of at least one of a setpoint quantity to be injected by the valve and a fuel pressure, and the uncorrected activation duration is corrected with the aid of a closing delay time correction value, which is ascertained as a function of the actual closing delay time.

19. The method as recited in claim 18, wherein the uncorrected activation duration is ascertained with the aid of a first characteristics map.

20. The method as recited in claim 18, wherein the setpoint closing delay time is ascertained as a function of at least one of a setpoint quantity to be injected by the valve and a fuel pressure, the closing delay time adaptation value is ascertained as a function of a deviation between the actual closing delay time and the setpoint closing delay time, and the closing delay time correction value is ascertained as a function of one of the setpoint quantity to be injected by the valve and the fuel pressure, and as a function of the closing delay time adaptation value.

21. The method as recited in claim 20, wherein the closing delay time correction value is ascertained with the aid of a third adaptive characteristics map, an input side of the third characteristics map being supplied the at least one of the setpoint quantity to be injected by the valve and the fuel pressure, and the third characteristics map being modified as a function of the closing delay time adaptation value.

22. The method as recited in claim 13, wherein at least one of a) an ascertaining of the actual closing delay time and b) the ascertaining of the closing delay time correction value, takes place at least one of periodically and in response to a presence of at least one specifiable acceptance condition.

23. The method as recited in claim 18, wherein the closing delay time correction value is subtracted from the uncorrected activation duration.

24. A control unit for operating an injection valve of an internal combustion engine of a motor vehicle activated with the aid of an actuator, where the actuator is activated using an activation signal characterizing a desired opening duration of the valve, the control unit configured to correct the activation signal characterizing the desired opening duration as a function of a valve delay time to obtain a corrected activation signal for activating the actuator, the valve delay time representing a temporal deviation between the activation signal and an actual change of an operating state of at least one component of the valve, to ascertain an uncorrected activation duration as a function of operating variables of the internal combustion engine, to correct the uncorrected activation duration with the aid of a closing delay time correction value, which is ascertained as a function of an actual closing delay time, to ascertain a setpoint closing delay time as a function of operating variables of the internal combustion engine, to ascertain a closing delay time adaptation value as a function of a deviation between an actual closing delay time and the setpoint closing delay time, to ascertain the closing delay time correction value as a function of operating variables of the internal combustion engine, and as a function of the closing delay time adaptation value, and to activate the actuator using the corrected activation signal.

25. A memory device storing a computer program including program-code for operating an injection valve of an internal combustion engine of a motor vehicle activated with the aid of an actuator, where the activator is activated using an activation signal characterizing a desired opening duration of the valve, the program code, when executed by a processing unit, causing the processing unit to perform the steps of:
correcting the activation signal characterizing the desired opening duration as a function of a valve delay time to obtain a corrected activation signal for activating the actuator, the valve delay time representing a temporal deviation between the activation signal and an actual change of an operating state of at least one component of the valve;
ascertaining an uncorrected activation duration as a function of operating variables of the internal combustion engine;
correcting the uncorrected activation duration with the aid of a closing delay time correction value, which is ascertained as a function of an actual closing delay time;
ascertaining a setpoint closing delay time as a function of operating variables of the internal combustion engine;
ascertaining a closing delay time adaptation value as a function of a deviation between an actual closing delay time and the setpoint closing delay time;
ascertaining the closing delay time correction value as a function of operating variables of the internal combustion engine, and as a function of the closing delay time adaptation value; and
activating the actuator using the corrected activation signal.

26. A computer-program product having program-code which are stored on a computer-readable data carrier, the program-code for operating an injection valve of an internal combustion engine of a motor vehicle activated with the aid of an actuator, where the activator is activated using an activation signal characterizing a desired opening duration of the valve, the program code, when executed by a processing unit, causing the processing unit to perform the steps of:
correcting the activation signal characterizing the desired opening duration as a function of a valve delay time to obtain a corrected activation signal for activating the actuator, the valve delay time representing a temporal deviation between the activation signal and an actual change of an operating state of at least one component of the valve;
ascertaining an uncorrected activation duration as a function of operating variables of the internal combustion engine;
correcting the uncorrected activation duration with the aid of a closing delay time correction value, which is ascertained as a function of an actual closing delay time;
ascertaining a setpoint closing delay time as a function of operating variables of the internal combustion engine;
ascertaining a closing delay time adaptation value as a function of a deviation between an actual closing delay time and the setpoint closing delay time;
ascertaining the closing delay time correction value as a function of operating variables of the internal combustion engine, and as a function of the closing delay time adaptation value; and
activating the actuator using the corrected activation signal.
